(19) United States
(12) Patent Application Publication
(10) Pub. No.: US 2008/0315798 A1
(43) Pub. Date: Dec. 25, 2008

(54) User Interface For Lighting Systems

(75) Inventors: Elmo Marcus Attila Diederiks, Eindhoven (NL); Bartel Marinus Van De Sluis, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/158,715

(22) PCT Filed: Dec. 13, 2006
(86) PCT No.: PCT/IB06/54797

§ 371 Date: Jun. 23, 2008

(30) Foreign Application Priority Data
Dec. 23, 2005 (EP) 05112857.7

(51) Int. Cl. H05B 37/02

(52) U.S. Cl. 315/312

(57) ABSTRACT

A user-friendly interface device (100) for interacting with complex, adjustable lighting systems includes a switch (110, 135) configured to provide control signals; and a controller (155) for controlling the lighting system (175) in response to the control signals. A first control signal is provided to change the mode of the lighting system (175), and a second control signal is provided to change light attributes associated with the mode. The interface device (100) may be handheld or wall-mounted. The controller may be configured for selecting the mode of operation, and for controlling the light within a mode of operation.

The present invention relates to user interface for controlling lighting systems for providing light of different attributes.

Early and current lighting systems in retail or residential environment are provided as fixed system. Modification of the characteristics of conventional lighting systems, such as changing the color of light or direction of the light, required adjustment at the lighting system. If the lighting system was in a difficult-to-reach or inconvenient location, significant effort was required to modify the system.

Lights systems are becoming more advanced, flexible and integrated, especially in the retail domain. All shops are equipped with a light system of some sort. These light systems are usually a one-time installation, or at least not replaced on a frequent basis. Such lighting systems offer limited flexibility, where they are mostly controlled manually in a cumbersome way. For instance changing the color requires the replacement of a color filter or the light source itself. Another example is the change of direction of spotlights, which typically requires the shop owner to climb up a stepladder and change the direction of the spot mechanically at an adjustable joint.

To ease the effort to modify a lighting system, systems have begun to be developed with multi-colored light sources, variable beam-width spots or automatically adjusting light sources or fixtures to change the direction of the light beam. However, the addition of these features has increased the complexity of the system in terms of modifying its characteristics.

User interfaces are desirable to control lighting systems that are complex in operation and that may happen to be in difficult-to-reach or inconvenient locations. Current user interfaces with remote control capabilities for lighting systems are bulky and complex devices that are not user-friendly to operate. One known lighting remote control is disclosed in U.S. Pat. No. 5,909,087, which is incorporated herein by reference in its entirety. Other controlled lighting methods and devices are disclosed in U.S. Patent Application Publication No. 2005/0047134, which is also incorporated herein by reference in its entirety. There is a need for a simple user interface that allows for control of various light sources and light attributes emanating there from.

Accordingly, a user-friendly interface device for controlling for lighting systems is provided, which may be hand-held or wall mounted for example. The interface device includes a switch configured to provide control signals; and a controller for controlling the lighting system in response to the control signals. A first control signal is provided to change the mode of the lighting system, and a second control signal is provided to change light attributes associated with the mode. The interface device may be handheld or wall-mounted. The controller may be configured for selecting the mode of operation, and for controlling the light within a mode of operation.

Further areas of applicability of the present invention will become apparent from the detailed description provided hereinafter. It should be understood that the detailed description and specific examples, while indicating exemplary embodiments of the invention, are intended for purposes of illustration only and are not intended to limit the scope of the invention.

These and other features, aspects, and advantages of the apparatus and methods of the present invention will become better understood from the following description, appended claims, and accompanying drawings where:

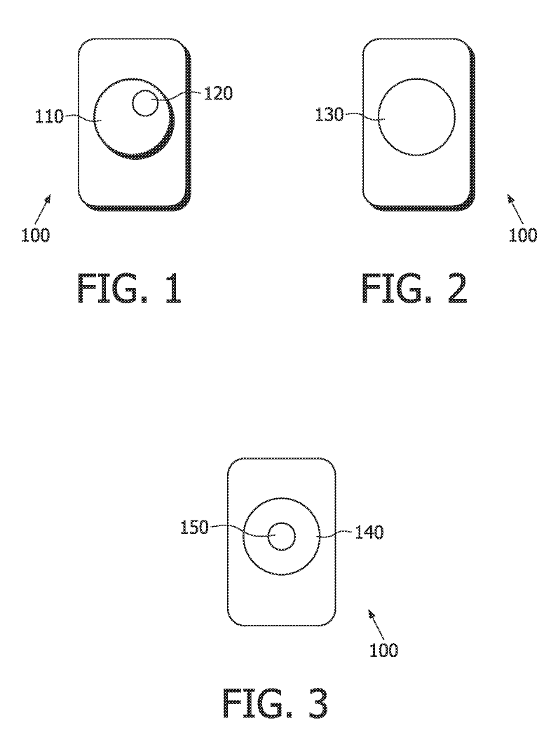

FIGS. 1-3 show various embodiments of an interface devices; and

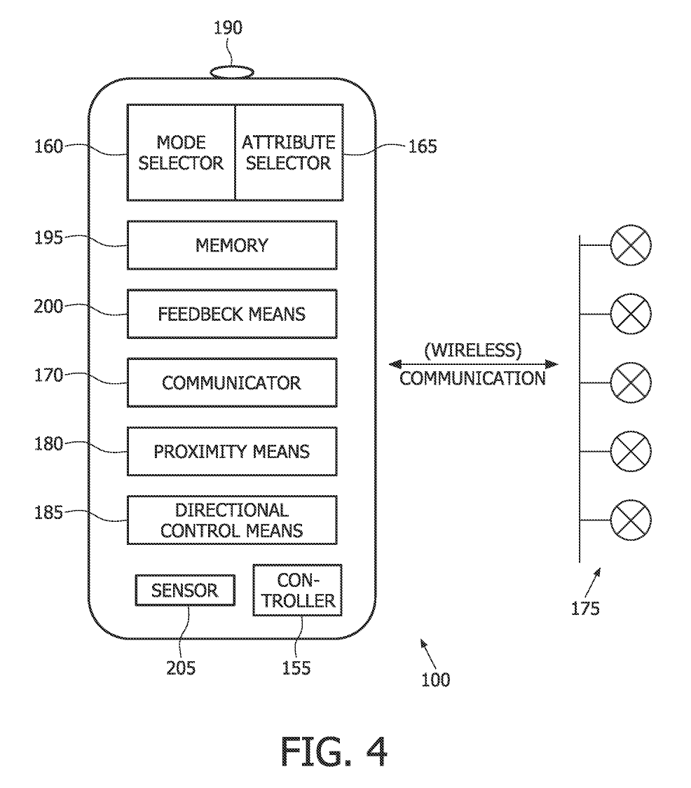

FIG. 4 shows a block diagram of the interface device.

The following description of certain exemplary embodiments is merely exemplary in nature and is in no way intended to limit the invention, its application, or uses. The term “lighting system” as used throughout includes, but is not limited to, any system having light sources, such as lighting panels, signage systems, flexible (rope) lighting, tube lighting, shelf lighting systems and the like. Reference to “lighting system” may also refer to a part or section of a lighting system or many lighting systems. Further, throughout this description, the term “button” or “switch” is used in reference to actuation means for activating the user interface. As a person skilled in the art will realize, the term “button” also refers to any other actuation means capable of providing various signals for changing light characteristics for example, such as a switch which may be rotary or slideable, mechanical button, software button, key or icon on a display screen, such as a touch sensitive display, or a touch controllable resistive or capacitive disc for selecting keys, icons or the like from a menus, such as drop down menus, or voice activation devices and the like, where in the case of voice activation, a voice recognition system to interpret and process voice commands is provided.

A user-friendly interface device for controlling variations of a lighting system, and methods of modifying a light using a user-friendly interface, includes means and/or acts for toggling between modes of operation, and for controlling the light within a particular mode of operation. Modes of operation include the possible variations possessed by a lighting system as instituted by the manufacturer/developer or user of the lighting system. Examples of different modes of operation include, but are not limited to, light color, light intensity, various different preset settings, beam direction, beam width and other light attributes. Upon actuation of a mode of operation, a user may now control the light within that mode.

Controlling the light within a particular mode of operation includes changing the characteristic of the light, for example, changing the color, intensity or presets, such as changing the affect the mode of operation has on the emitted light (usual in a positive or negative manner), for example, increasing the light's intensity or decreasing the light's intensity in the intensity mode; changing the color in the color mode; or changing presets or toggling among various presets in the preset mode, for example. The interface device may be either handheld devices or wall-mounted.

For brevity and clarity, only a brief discussion will be given regarding detailed operation of specific lighting systems that are well known in the art. It is to be understood that the lighting elements that form the lighting systems are capable of reproducing visible light having essentially any desired color, intensity or other attributes such as hue, saturation, spot size, beam width, beam direction and the like. Further, it should be understood that any suitable controllable multi-color light emitting elements or sources may be used, such as incandescent, fluorescent, halogen, high intensity discharge (HID) and the like, where light emitting diodes (LEDs) are particularly well suited for providing color-changeable light.

FIG. 1 shows one embodiment of the interface device 100 which comprises an activation device such as knob in the form of a rotary dial 110 with a button 120, for example. Of course instead of a rotary dial, a slideable switch may be used. The button 120 is suitable for toggling between the different modes of operation, whereby when the button 120 is actuated, e.g., pressed or touched or selected from a menu in the case of a software button for example, a new mode of operation is accessible for modification by rotating the rotary dial 110. Pressing this button 120 could change the mode from intensity mode (where rotation of dial 110 changes the intensity of the light, such as dims the light), to color mode (where different colors are selected or cycled through, e.g., via short presses of the button 120 or selection from menus or icons in the case of a software button), to selecting presets mode where presets may be provided by professional lighting designers, or created, stored and modified by users of the lighting system. Visual feedback on the knob itself, or any portions of the interface device 100, may indicate these different modes.

Of course, the button 120 may be dispensed with and instead the rotary dial 110 or a slideable switch itself may be pressed (for long durations) to change modes, where once a mode is selected, pressing the dial 110 for short duration may toggle through the various light characteristic of the selected mode, such as changing colors in the color mode in discrete steps from red (R) to green (G) to blue (B) and back to red, which may be in larger steps than finer changes in color achieved by rotating the dial 110.

The rotary dial 110 or a slideable switch is suitable for controlling the lighting system in a particular mode set by toggling the button 120. In particular, turning the rotary dial 110 in one direction, e.g., clockwise, (or moving a slider switch up) modifies the light in one sense, such as increasing the light intensity if in the intensity mode, or changing the light color (continuously or discretely) when in the color mode, or changing (continuously or discretely) the presets in the preset mode. Turning the rotary dial 110 in the other directions, e.g., counter-clockwise (or moving a slider switch down), affects the mode in a different way, i.e., modifies the light in another sense, such as decreasing the light intensity etc.

FIG. 2 is another embodiment of the interface device 100, where the rotary dial 110 and button 120 of FIG. 1 are replaced with a touch sensitive element 130, which may be a resistive or capacitive disc, or display screen accessible by input/output devices such as a keyboard or a pointing device such as a mouse. Illustratively, the display is a touch sensitive display screen accessible and controllable with any pointing device, such as a pen, pointer, or a user's finger, for example. To change modes of operation, the resistive or capacitive disc, or touch sensitive display 130 may be tapped (anywhere or at a designated area) by the user's finger, for example.

To change light attributes in a particular mode, the user may rotate his finger touching the capacitive disc 130 in clockwise and counter-clockwise directions, or up and down directions as describe in connection with FIG. 1. In the case where the touch sensitive element 130 is a touch sensitive screen, various lighting modes and light attributes may be chosen through a simulated software wheel displayed on the screen, which may also include a toggle button 140 as will be described in connection with FIG. 3. Instead of software buttons or wheels, the touch sensitive screen is configured to display menus for selection and navigation by touching the screen with a pointer or a finger, for example.

FIG. 3 is yet a further embodiment the interface device 100 similar to the one shown in FIG. 2 but additionally has a button 150 or designated area on the resistive or capacitive disc 140. In use, the button 150 is suitable for toggling amongst the different modes of operation, and the resistive or capacitive disc 140 is useful for controlling the light attributes associated with the particular modes as described.

Particular elements for controlling a light system with the user-friendly interface device 100 will now be discussed. FIG. 4 shows the various elements included in the interface device 100, such as mode selector 160, e.g., keys, buttons and the liked, for selecting the mode of operation, and attribute selector 165 for selecting light attributes within a selected mode of operation. The mode selector 160 and attribute selector 165 may include in any combination for example the rotary or slideable switch 110, buttons 120, 150, and the touch sensitive disc or screen 130, 140 described in connection with FIGS. 1-3.

As shown in FIG. 4, the interface device 100 further includes a controller 155 that receive signals from the mode and attribute selectors 165, 16, e.g. from the rotary knob and button(s) of the interface device 100 and, in response thereto, generates control signals to control light fixture(s) to change modes thereof and attributes of light emanating therefrom. The interface device 100 also includes communication elements 170 for communicating between the interface device 100 and the lighting system 175, e.g., via a wireless interface.

As is well known in the art, the communication elements 170, as well as a similar elements in the lighting system 175 include wired or wireless systems having a transceiver for transmitting and receiving signals through wires or a wireless interface, in which case an antenna is coupled to the transceiver through a duplexer that isolates transmitting and receiving portions of the transceiver. Modulators, demodulators and filters may also be used to extract information signals from carrier signals for further processing, such as by a processor coupled to a memory for storing data including an operating system or operating instructions to be executed by the processor. The processor may be any type of controller or processor, such as those described in U.S. 2003/0057887, that is capable of providing control signals in response to input signals from the mode and attribute selectors 160, 165, for example, executing instruction stored in the memory, which may be any type of memory, RAM, ROM, removable memory, CD-ROM, and the like, also as described in U.S. 2003/0057887. The various circuit elements shown in FIG. 4 may be integrated together in any combinations or may be separate units interconnected together. Illustratively, the interface device 100 and lighting system 175 communicate wirelessly via limited range technology such as Zigbee™ or Bluetooth™ protocols.

Localization or proximity elements 180 are also provides for determining the location of the interface device 100 in relation to the lighting system 175. Illustratively, the localization or proximity elements 180 may include sensors and transceivers configured to operate using radio frequency (RF), infrared, ultrasound, laser, or combinations thereof. One infrared proximity and remote control wall switch is disclosed in U.S. Pat. No. 6,107,938, which is incorporated herein by reference in its entirety.

It should be noted that the proximity elements 180 may be implicitly implemented by using such limited range protocols like Zigbee™ or Bluetooth™ protocols, particularly when the various sets of lighting fixtures or systems are not too close to each other, so that only one set of lighting fixtures (or lighting system) is in the range of the interface device 100 using Zigbee™ or Bluetooth™ at any one location of the interface device 100. Each lighting fixture, or set of lighting fixtures or systems may have its own identifying information which is communicated to the interface device, so that for example, various presets are associated with particular ones of the lighting fixtures, sets or systems.

The interface device 100 also includes directional control devices 185 to allow the selection of lighting systems 175 or part of a lighting system 175 by the user where, for example, such directional control devices 185 may include an infrared or modulated laser light source, also shown as reference numeral 190. Using a laser beam to point and selects light fixture or systems provides feedback, e.g., a visual laser point, for the user to see and aim at the light source(s) to be selected. For example, a light source or group of light sources can be selected by pointing a laser from a laser source 190 on the interface device 100, and subsequently toggling a button or tapping the disc or screen of the interface device 100. The light fixtures may have controllers and a receiver that are configured to detect a selection thereof by the interface device 100, such as detecting the laser beams.

One remote controlled lighting apparatus is disclosed in U.S. Patent Application Publication No. 2003/0107888, which is incorporated herein by reference in its entirety, and includes selecting a lighting module by pointing the remote control at the lighting module, for subsequent control thereof such as changing light spot size and color. Presets as disclosed in US 2003/0107888 may be preconfigured light settings such as for romance, TV watching, reading and the like. The presets may be stored in the memory 195 of the interface device 100 or a memory of the lighting system 175 for recall, as well as for modification and entry of new settings or new presets. The presets may include predetermined attributes of lights emanating from light sources of the lighting system 175, as well as control of light fixtures, such as pan and tilt control of motors for example to change pointing direction of the light fixtures and thus the light emanating there from.

The presets may be stored in the memory 195 of the interface device 100, either by the manufacturer/developer of the interface device 100 or the user. For example, a user may store a new preset by holding the button on the interface device 100 for a sustained period of time such as 2-4 seconds. After storage of the new preset, the interface device 100 would provide an indication such as by either a visual or audio feedback provided by feedback means 200. The feedback means 200 may also be configured to indicate to the user when a mode of operation has been actuated, for example, and when the lighting system 175 has been modified. An alternative way would be to store a lighting preset if it remains unchanged for a certain amount of time (e.g. >1 hour) since this can be regarded as an implicit feedback from the user that the lighting preset is appreciated.

The interface device 100 may be handheld or wall mounted and may include sensor(s) 205 configured to sense that the interface device 100 is mounted on a wall. The sensor may include a motion sensor that senses movement of the interface device 100. Alternatively, the sensor may be a simple switch which is activated or deactivated when the interface device 100 is mounted on the wall, such as by being pressed when mounted on the wall. The switch may also be a magnetic switch similar to those used in alarm systems to arm windows or doors, which may have two parts, one part being located in the wall (or the interface device 100) for example, and being a magnet. The other part of the sensor is located in the interface device 100 (or the wall) and includes an arm attracted or repelled by the magnet when the two parts are brought in close proximity, such as when the interface device 100 is mounted on the wall.

In use, the lighting system could determine whether the interface device is being used in its handheld mode or wall-mounted mode through the sensor means 205. When used as a wall-mounted unit, the interface device could control either the whole lighting system, or the part of the lighting system closest to its proximity. Also, when used as a wall-mounted unit, the interface device may exhibit different presets from those offered when it was used in its handheld mode. In the event the interface device 100 is used solely as a wall-mounted unit, it is not required for the device 100 to contain the sensor 205 or the proximity device(s) 180. In the handheld mode, the control unit or interface device 100 could control the lights that are in the direct proximity of the user holding the control unit, such as via limited range communication protocols like Zigbee™ and Bluetooth™, for example.

Furthermore, the control modes can differ in these two situations, namely when the interface device 100 is handheld (or not attached to the wall) and when it is attached to the wall. For example when the interface device 100 is hanging on the wall, the interface device 100 can offer presets and intensity control (dimming) as the control modes. By contrast, when the interface device 100 is held by the user, it can offer color control and intensity control (dimming) as control modes. In addition, the interface device 100 may be configured to have default control modes (e.g. when it is not being used for a certain period of time) that are different in the two situations. For instance, when the interface device 100 is hanging on the wall, the current mode may be the default control mode; while when the user holds the interface device 100, the default control mode may be the intensity mode to provide intensity control such as dimming. Of course, the default mode may be settable or programmable by the user, for example.

The interface device 100 allows the user to easily select a mode of operation, such as intensity, color, presets and so on, such as via a simple press of a button, rotation of a knob, rotational movement of the user's finger on a resistive or capacitive disc, or through a touch sensitive screen that display software switch(es), wheels, icons, menus or the like.

The user now can easily control light fixtures and/or light attributes of light emanating therefrom. For instance, the user can toggle a button or tap on the capacitive disc to toggle to the intensity mode, and then dim the lights via the rotary knob or finger rotation over the capacitive disc, for example. If the user toggles to the color mode, then the user can navigate through a color circle via the rotary knob or capacitive disc, for example. Instead of continuous color change via rotation through a color R-G-B circle, color presets may be stored and the user can go through the available presets. In this case, the system can offer discreet steps, where each step is a preset, or the system could provide a continuous control by cross fading between presets. This color control can be realized by means of a continuous control such as continuous rotation of the rotary knob.

Finally, the above-discussion is intended to be merely illustrative of the present invention and should not be construed as limiting the appended claims to any particular embodiment or group of embodiments. Thus, while the present invention has been described in particular detail with reference to specific exemplary embodiments thereof, it should also be appreciated that numerous modifications and changes may be made thereto without departing from the broader and intended spirit and scope of the invention as set forth in the claims that follow. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function; and
e) each of the disclosed elements may be comprised of hardware portions (e.g., discrete electronic circuitry), software portions (e.g., computer programming), or any combination thereof.

1. An interface device for controlling a lighting system to provide a light, the interface device comprising:
a switch configured to provide control signals; and
a controller for controlling said lighting system in response to said control signals;
wherein a first signal of said control signals is provided to change a mode of said lighting system, and a second signal of said control signals is provided to change light attributes associated with said mode.

2. The interface device of claim 1, wherein said switch is configured to be pressed or tapped to provide said first signal for toggling among said modes.

3. The interface device of claim 1, wherein said switch is configured to be at least one of rotated or slid to change provide said second signal for changing said light attributes.

4. The interface device of claim 1, wherein said modes include an intensity mode, a color mode and a preset mode.

5. The interface device of claim 1, wherein said color mode is for changing at least one of hue, saturation and a combination of said hue and said saturation of said light.

6. The interface device of claim 1, wherein said light attributes associated with an intensity mode include intensity of said light; said light attributes associated with a color mode includes color of said light; and said light attributes associated with a preset mode includes at least one of predetermined ones of said intensity, said color, beam direction of said light, beam width of said light.

7. The interface device of claim 1, wherein said modes include presets, a new one of said presets being stored in a memory of said interface device by holding or pressing said switch for a sustained period of time.

8. The interface device of claim 6, wherein said controller is configured to provide an indication when said new one of said presets is stored in said memory.

9. The interface device of claim 1, wherein said modes include presets, said controller being configured to store a new one of said presets when a setting of said lighting system remains unchanged for a predetermined period.

10. The interface device of claim 1, further comprising a sensor configured to detect whether said interface device is mounted on a wall; wherein a default wall preset associated with said interface device when mounted on said wall is different from a default remote preset when said interface device is not mounted on said wall.

11. The interface device of claim 1, further comprising a sensor configured to detect whether said interface device is mounted on a wall; wherein a default wall control mode associated with said interface device when mounted on said wall is different from a default remote control mode when said interface device is not mounted on said wall.

12. A method for controlling a lighting system comprising the acts of:
pressing a switch to change modes of said lighting system; and
providing a rotational or slideable movement of said switch or over said switch to change light attributes associated with said modes of light emanating from said lighting system.

13. The method of claim 12, wherein said modes include an intensity mode, a color mode and a preset mode.

14. The method of claim 12, wherein said light attributes associated with an intensity mode includes intensity of said light; said light attributes associated with a color mode includes color of said light; and said light attributes associated with a preset mode includes at least one of predetermined ones of said intensity, said color, beam direction of said light, beam width of said light.

15. The method of claim 12, further comprising the act of storing a preset of said light attributes by holding or pressing said switch for a sustained period of time.

16. The method of claim 12, further comprising the act of providing an indication when a preset of said light attributes is stored.

17. The method of claim 12, further comprising the act of storing a preset of said light attributes when said light attributes of light emanating from said lighting system remain unchanged for a predetermined period.

18. The method of claim 12, further comprising the act of detecting whether an interface device for controlling said lighting system is mounted on a wall; wherein a default wall preset associated with said interface device when mounted on said wall is different from a default remote preset when said interface device is not mounted on said wall.
